(19) United States
(12) Patent Application Publication
(10) Pub. No.: US 2008/0096506 A1
(43) Pub. Date: Apr. 24, 2008

(54) Method and apparatus for secure voice communication

(75) Inventors: John C.V. Nguyen, Naperville, IL (US); David S. Benco, Winfield, IL (US); Paresh C. Kanabar, Naperville, IL (US); Huixian Song, Naperville, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/582,725

(22) Filed: Oct. 18, 2006

(51) Int. Cl. H04B 1/18

(52) U.S. Cl. 455/187.1

(57) ABSTRACT

A method and apparatus for secure voice communication are provided. More particularly, the present techniques are directed to the introduction of voice security for mobile-to-mobile calls. The coding and decoding is accomplished by handset vocoders, in lieu of coding and decoding accomplished by the network. In this regard, when voice security is determined to be necessary, users select a secured transmission protocol and communicate the selection to the network. All coding and decoding is then performed only in the handsets, as opposed to the network. Moreover, the vocoders implemented, in at least one form, employ security encryption, so that only the two connected mobile users are able to understand the content of the voice transmission.

### BACKGROUND OF THE INVENTION

This invention relates to a method and apparatus for secure voice communication. More particularly, the present techniques are directed to the introduction of voice security for mobile-to-mobile calls. The coding and decoding is accomplished by handset vocoders, in lieu of coding and decoding accomplished by the network. In this regard, when voice security is determined to be necessary, users select a secured transmission protocol and communicate the selection to the network. All coding and decoding is then performed only in the handsets, as opposed to the network. Moreover, the vocoders implemented, in at least one form, employ security encryption, so that only the two connected mobile users are able to understand the content of the voice transmission.

While the invention is particularly directed to the art of secure voice communication, and will be thus described with specific reference thereto, it will be appreciated that the invention may have usefulness in other fields and applications. For example, the invention may be used in connection with secure data communication techniques as well.

By way of background, voice coding and decoding in wireless networks is typically controlled by switching elements such as mobile switching center (MSC). For example, in mobile-to-mobile communications, a vocoder is typically positioned at the originating switch, or originating mobile switching center (MSC), for the calling subscriber. Another vocoder is typically positioned at the terminating switch, or mobile switching center (MSC) at the network. The vocoders used in this way typically improve efficiency within the network. These vocoders are typically not secure vocoders.

With reference now to FIG. 1, a network 10, illustrates these principles. For example, a mobile device 12 communicates with a base station (BS) 14 to initiate a call. The base station 14 sends a transmission to the mobile switching center (MSC) 16 using enhanced variable rate coding (EVRC) protocol messages. The mobile switching center (MSC) 16, which includes a vocoder 18, is able to code the message in pulse code modulation (PCM) format and transmit the messages to the public switched telephone network (PSTN) 20. The network eventually transmits the PCM-coded transmission to a terminating mobile switching center (MSC) 22. The terminating mobile switching center (MSC) 22 also includes a vocoder 24 to decode the message. The terminating mobile switching center (MSC) 22 then transmits to the base station (BS) 16. Notably, the transmission between the MSC 22 and the base station (BS) 26 is in EVRC format. Ultimately, a transmission is sent to the mobile device 28.

Currently configured networks, such as that of FIG. 1, do not include elaborate provisions for implementing security measures for voice transmissions. As such, it is not typically possible for users to engage in secure transmissions. Unauthorized third parties may tap into the voice transmission. The vocoders 18 and 24 of FIG. 1 are typically deployed and implemented for efficiency purposes, not security purposes.

The present invention contemplates a new and improved technique that resolves the above-referenced difficulties and others.

### SUMMARY OF THE INVENTION

A method and apparatus for secure voice communication are provided.

In one aspect of the invention, the system comprises a first mobile device having a first voice security activation module and a first vocoder, the first voice security activation module operative to selectively initiate a secure voice communication session for the first mobile device by transmitting a first message and the first vocoder operative to selectively code, decode, encrypt and decrypt messages during the secure voice communication session, a second mobile device having a second voice security activation module and a second vocoder, the second voice security activation module operative to selectively initiate the secure voice communication session for the second mobile device by transmitting a second message and the second vocoder operative to selectively code, decode, encrypt and decrypt messages during the secure voice communication session, a first switching element operative to receive the first message from the first mobile device and to bypass the selected vocoding functions in the network during the secure voice communication session based on the first message, and, a second switching element operative to receive the second message from the second mobile device and to bypass the selected vocoding functions in the network during the secure voice communication session based on the second message.

In another aspect of the invention, the first mobile device includes a button associated with the first secure voice communication module.

In another aspect of the invention, the button is a hardware-based button.

In another aspect of the invention, the button is a software-based button.

In another aspect of the invention, the first message includes a service option request field populated with a unique identifier.

In another aspect of the invention, the second message includes a service option request field populated with a unique identifier.

In another aspect of the invention, the first switching element is a mobile switching center.

In another aspect of the invention, the second switching element is a mobile switching center.

In another aspect of the invention, the system comprises a first switching element operative to receive a first message from a first mobile device, the first message indicating an initiation of a secure voice communication session, and to bypass the selected vocoding functions in the network during the secure voice communication session based on the first message, and, a second switching element operative to receive a second message from a second mobile device, the second message indicating initiation of the secure voice communication session for the second mobile device, and to bypass the selected vocoding functions in the network during the secure voice communication session based on the second message.

In another aspect of the invention, the first message includes a service option request field populated with a unique identifier.

In another aspect of the invention, the second message includes a service option request field populated with a unique identifier.

In another aspect of the invention, the first switching element is a mobile switching center.

In another aspect of the invention, the second switching element is a mobile switching center.

In another aspect of the invention, the method comprises initiating a secure voice communication session by a first user of a first mobile device and a second user of a second mobile device,

performing vocoding functions by the first mobile device on a message to be sent during the secure voice communication session to obtain a coded message, encrypting the coded message by the first mobile device to obtain an encrypted message, transmitting the encrypted message by the first mobile device, receiving the encrypted message by the second mobile device, decrypting the encrypted message by the second mobile device to obtain a decrypted message, and, performing vocoding functions on the decrypted message by the second mobile device to obtain a decoded message.

In another aspect of the invention, the initiating comprises manipulating a button on the first mobile device.

In another aspect of the invention, the initiating comprises manipulating a button on the second mobile device.

In another aspect of the invention, the method further comprises receiving the encrypted message from the first mobile device to initiate a secure-voice communication session, bypassing selected vocoding functions in the network based on the encrypted message, and, restoring the selected vocoding functions upon completion of the secure voice communication session.

In another aspect of the invention, the method further comprises receiving a special message from the second mobile device to initiate a secure voice communication session, bypassing selected vocoding functions in the network based on the special message, and, restoring the selected vocoding functions upon completion of the secure voice communication session.

In another aspect of the invention, a method for providing secure voice communication in a network, the method comprises receiving a special request from a mobile device to initiate a secure voice communication session, bypassing selected vocoding functions in the network based on the special request, and, restoring the selected vocoding functions upon completion of the secure voice communication session.

In another aspect of the invention, the method further comprises receiving a second special request from a second mobile device to initiate a secure voice communication session, bypassing the selected vocoding functions in the network based on the second special request, and, restoring the selected vocoding functions upon completion of the secure voice communication session.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram of an exemplary telecommunications network.

FIG. 2 is a block diagram of an exemplary telecommunications network into which the present invention is incorporated.

FIG. 3 is a mobile device according to the presently described embodiments.

FIG. 4 is a mobile switching center according to the presently described embodiments.

FIG. 5 is a flow chart illustrating a method according to the presently described embodiments.

FIG. 6 is a flow chart illustrating a method according to the presently described embodiments.

### DETAILED DESCRIPTION

As noted above, current state-of-the-art does not secure a normal voice call in manners contemplated by the presently described embodiments. The typical voice call may be tapped into by unauthorized parties.

However, according to the presently described embodiments, a voice call can be conducted using suitable security protocols that are configurable by the users and transparent to the network. Thus, the network will be able to pass the call through, but no unauthorized party on the network will be able to understand the content of the call.

In one form, the calling party and called party indicate to each other that they will engage in a secure voice communication session. Then, each party presses a special button (either a hardware or software type button) that will trigger appropriate switches (e.g. an originating mobile switching center and a terminating mobile switching center) to bypass, or disable, its conventional vocoder functions. As a result, only vocoders implemented on the mobile device will be activated and remain in the speech path. The vocoders within the mobile device not only code and decode messages but also encrypt the transmission so that no other party in the network can listen to the conversation. After completion of the secure voice communication session, the network vocoding functions are restored.

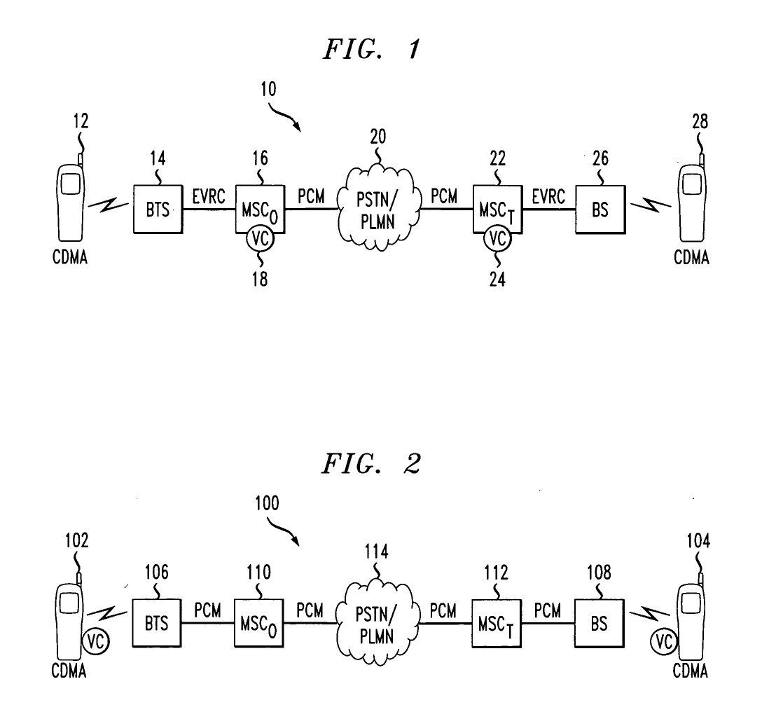

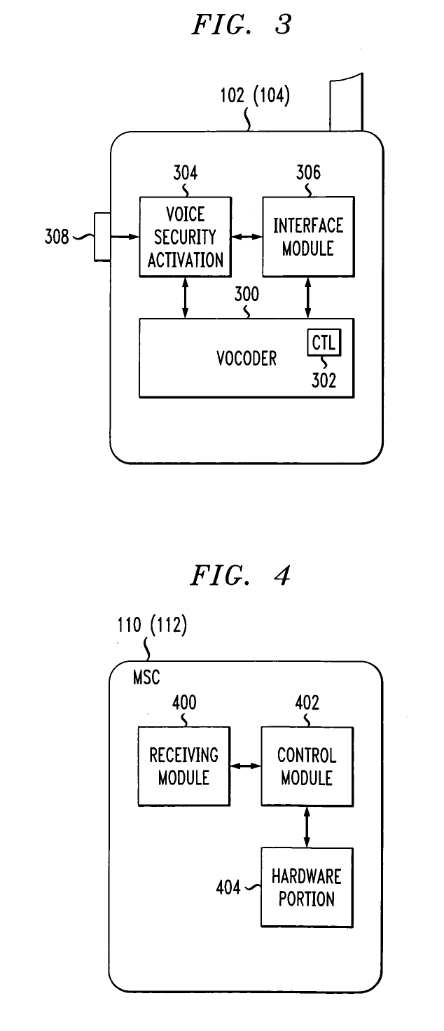

Referring now to the drawings wherein the showings are for purposes of illustrating the exemplary embodiments only and not for purposes of limiting the claimed subject matter, FIG. 2 provides a view of a system into which the presently described embodiments may be incorporated. As shown generally, FIG. 2 shows a network 100. The network 100 includes mobile devices 102 and 104 which include vocoders as will be described in more detail in connection with FIG. 3. Also shown in the network are base stations 106 and 108, as well as mobile switching centers (MSCs) 110 and 112, which will be described in greater detail in connection with FIG. 4. Of course, the network is connected and in communication with the public switched telephone network (PSTN) 114. It should be appreciated that all messaging may be accomplished in this configuration in pulse code modulation (PCM) format.

More specifically, with reference now to FIG. 3, a mobile device 102, or 104, is illustrated. The mobile devices may take a variety of forms and configurations. For example, the mobile device may be a wireless phone, a personal digital assistant, a personal computer, a wireless browser, . . . etc. In at least one form, however, the mobile device 102 (or 104) includes a vocoder 300 which has a software control portion 302. Also included within the mobile device is a voice security activation module 304 and interface module 306.

The vocoder 300 is operative, under control of the software control portion 302, to selectively code, decode, encrypt and decrypt messages during the secure voice communication session. Vocoding may be accomplished using a variety of different vocoding techniques and/or vocoders. For example, a CDMA vocoder may be used. Alternatively, an 8K vocoder, a 13K vocoder, an EVRC (Enhanced Variable Rate Coding) vocoder, or an SMV (Selectable Mode Vocoding) vocoder may be used. As still further alternatives, a QCELP—Qualcomm Code Excited Linear Prediction vocoder, an ACELP—Adaptive Code Excited Linear Prediction vocoder or an ADPCM—Adaptive Differential Pulse Code Modulation vocoder may be used.

Encryption may be accomplished using any of a variety of encryption techniques. For example, the following techniques will suffice.

RSA: RSA is a public-key cipher developed by (and named after) Ron Rivest, Adi Shamir, and Leonard Adleman, in the late 1970's. RSA is the “standard” public-key encryption algorithm. RSA is a variable-length key. Common key lengths are 256, 512, 768, 1024 and 2048.

Blowfish: Blowfish is a block cipher algorithm developed by Bruce Schneider. Blowfish is a variable-length key algorithm. The most common key lengths are 128-bit and 160-bit. Blowfish can be used domestically but cannot be exported.

CAST: Cast is a 64-bit symmetric block cipher developed by C. M. Adams and S. E. Tavares. CAST is similar to DES but is a proprietary encryption system. MS Exchange uses CAST for symmetric key encryption.

DES: DES is a block cipher algorithm developed by the National Institute of Standards and Technology (NIST) Data Encryption Standard. DES has a fixed key length of 56 bits. DES cannot be exported.

IDEA (International Data Encryption Algorithm): IDEA is a 128-bit block cipher developed by James Massey and Xuella Lai in 1990. Encryption products developed in the US that use IDEA encryption cannot be exported, but IDEA was developed in Zurich and is commonly used in Europe.

RC2: RC2 is a block cipher algorithm developed by RSA Data Security, Inc. The key-length is variable but typically limited to 40 bits so that RC2 can be used for both domestic and international encryption. RC2 is a commonly-used international encryption algorithm.

RC4: RC4 is a stream cipher developed by RSA Data Security, Inc. The key-length is variable but typically limited to 40 bits so that RC4 can be used both for domestic and international encryption. A 40-bit version of RC4 is used by MS Office 97 for data encryption. A domestic, 128-bit version of RC4 is available for domestic encryption.

Skipjack: Skipjack is a symmetric block cipher used by the Clipper and Capstone chips. Skipjack has a fixed key length of 80 bits.

Triple DES: Triple DES is a version of DES that encrypts a message or file three times using the DES 56-bit key. A plain text message or file is encrypted using DES. The encrypted message is again encrypted using DES, and the twice-encrypted message is encrypted a third time using DES.

The voice security activation module 304 is operative to selectively initiate a secure voice communication session for the first mobile device by transmitting a message to the network. In one form, the message, e.g. a special message, includes a service option request field populated with a unique identifier indicating to the network that a secure voice communication session is being initiated.

The interface module 306 may take a variety of forms. In one form, it is operative to transmit and receive messages necessary for communication according to the presently described embodiments. For example, it is operative to transmit the special messages contemplated above.

FIG. 4 illustrates a switching element, e.g. mobile switching center 110 or mobile switching center 112, which may be implemented within the presently described embodiments. The mobile switching center (MSC) includes a receiving module 400 which is in communication with a control module 402. Control module 402 also communicates with a hardware portion 404. The mobile switching centers (MSCs) are operative to receive special messages (described above) from the mobile devices and to bypass the selected vocoding functions in the network during the secure voice communication session based on those special messages.

It should be understood that the described switching element, e.g. the mobile switching center, may also provide a variety of other functions to the network not described herein for the sake of brevity. It should also be understood that, in lieu of a mobile switching center, other types of switching elements may be provided with the functionality of the presently described embodiments. These types of alternatives may be dependent on the design of the network and/or the technological generation of the network.

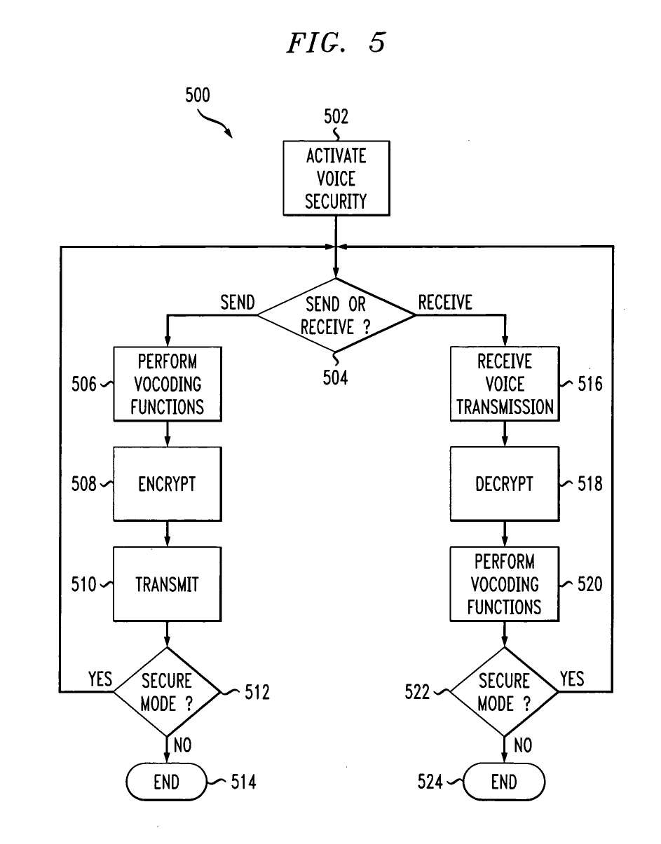

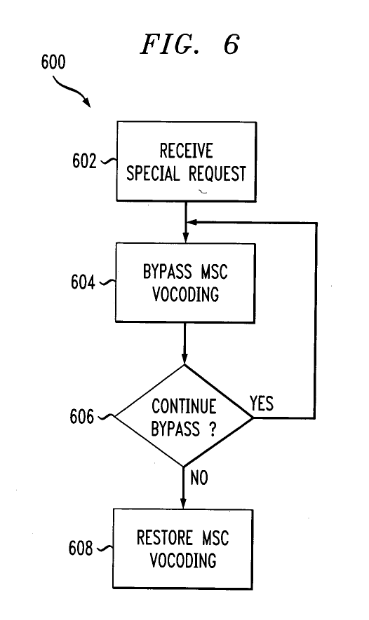

With reference now to FIGS. 5 and 6, methods 500 and 600 according to the presently described embodiments are illustrated. It should be appreciated that the methods of FIGS. 5 and 6 can be implemented using a variety of software techniques and hardware configurations that will be apparent to those skilled in the art upon reading the present disclosure. However, in one form, the method described in connection with FIG. 5 may be implemented in the software control section 302 of mobile device 102. Likewise, the method of FIG. 6, in one form, may be implemented within the mobile switching center 110. In this regard, the software routine that enables the appropriate hardware changes may be included in the receiving module 400 and/or the control module 402.

Of course, in the forms described above, the software is at least partially centralized. However, it should be understood, that the software may also be distributed in a variety of suitable manners within the network.

With reference back now to FIG. 5, the method 500 is initiated by activation of the voice security mode (at 502). This may be accomplished through the activation of the voice security activation module 304. Such activation or initiation may be accomplished through use of a software or hardware button on the mobile device 102. Manipulation of the button will generate a message that will typically include a feature service option request field. To activate the voice security features, the service option request field is populated with an appropriated identifier in the voice secured activation module and transmitted to the MSC 110 through the interface module 306.

It should be understood that the mobile device 104 is also typically activated into the voice security mode so that transmission can occur.

Once the mobile devices are in the voice security mode, each mobile device will determine whether it is sending or receiving the transmission (at 504). In this regard, the mobile devices will simply wait to either receive a transmission or wait for the user to speak to send the transmission.

If the mobile device is sending a voice transmission, appropriate vocoding functions are performed (at 506). Next, the transmission is encrypted (at 508).

Once encrypted, the message(s) are then transmitted (at 510). If the communication is to remain in a secure mode, the device simply waits to send or receive the voice transmission. If, however, secure voice communication is abandoned, the routine is ended (at 514).

Likewise, if the mobile device is to receive voice transmissions, the transmission is received (at 516). The data is then decrypted (at 518). Techniques noted above may be used in the decryption process. Next, vocoding functions are performed on the data. (at 520). Again, vocoding techniques contemplated above may be used to decode. At this point, the user who receives the voice transmission can listen and understand the transmission. If the mobile unit is to remain in the secure mode (at 522), it simply awaits further transmissions or the sending of further transmissions. If the secure mode is to be discontinued, the routine is simply ended (at 524).

With reference now to FIG. 6, a method according to the present invention, from the perspective of a mobile switching center, is described. In this regard, a method 600 includes a step of receiving a special request, e.g. a message from a first mobile device or a message from a second mobile device (at 602). In one form, the special request is received in the form of a message having a format that provides a service option request field. The service request option field is, according to the presently described embodiments, populated with a unique identifier. As noted above, once the identifier in this field is identified, the control section of the switching element, e.g. the mobile switching center 110, transmits appropriate messaging from the control module 402 to the hardware portion 404 of the switching element, e.g. the mobile switching center 110. As a result, the conventional vocoding that is accomplished by the switching element, e.g. the mobile switching center, is discontinued or bypassed (at 604). If the secure voice communication session is to continue, the bypass continues (at 606). However, if the bypass of the conventional vocoding is to be discontinued, the conventional vocoding of the network is restored (at 608).

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A system providing secure voice communication in a network operative to perform selected vocoding functions, the system comprising:
a first mobile device having a first voice security activation module and a first vocoder, the first voice security activation module operative to selectively initiate a secure voice communication session for the first mobile device by transmitting a first message and the first vocoder operative to selectively code, decode, encrypt and decrypt messages during the secure voice communication session;
a second mobile device having a second voice security activation module and a second vocoder, the second voice security activation module operative to selectively initiate the secure voice communication session for the second mobile device by transmitting a second message and the second vocoder operative to selectively code, decode, encrypt and decrypt messages during the secure voice communication session;
a first switching element operative to receive the first message from the first mobile device and to bypass the selected vocoding functions in the network during the secure voice communication session based on the first message; and,
a second switching element operative to receive the second message from the second mobile device and to bypass the selected vocoding functions in the network during the secure voice communication session based on the second message.

2. The system as set forth in claim 1 wherein the first mobile device includes a button associated with the first secure voice communication module.

3. The system as set forth in claim 2 wherein the button is a hardware-based button.

4. The system as set forth in claim 2 wherein the button is a software-based button.

5. The system as set forth in claim 1 wherein the first message includes a service option request field populated with a unique identifier.

6. The system as set forth in claim 1 wherein the second message includes a service option request field populated with a unique identifier.

7. The system as set forth in claim 1 wherein the first switching element is a mobile switching center.

8. The system as set forth in claim 1 wherein the second switching element is a mobile switching center.

9. A system for providing secure voice communication in a network operative to perform selected vocoding functions, the system comprising:
a first switching element operative to receive a first message from a first mobile device, the first message indicating an initiation of a secure voice communication session, and to bypass the selected vocoding functions in the network during the secure voice communication session based on the first message; and,
a second switching element operative to receive a second message from a second mobile device, the second message indicating initiation of the secure voice communication session for the second mobile device, and to bypass the selected vocoding functions in the network during the secure voice communication session based on the second message.

10. The system as set forth in claim 9 wherein the first message includes a service option request field populated with a unique identifier.

11. The system as set forth in claim 9 wherein the second message includes a service option request field populated with a unique identifier.

12. The system as set forth in claim 9 wherein the first switching element is a mobile switching center.

13. The system as set forth in claim 9 wherein the second switching element is a mobile switching center.

14. A method for providing secure voice communication in a network, the method comprising:
initiating a secure voice communication session by a first user of a first mobile device and a second user of a second mobile device;
performing vocoding functions by the first mobile device on a message to be sent during the secure voice communication session to obtain a coded message;
encrypting the coded message by the first mobile device to obtain an encrypted message;
transmitting the encrypted message by the first mobile device;
receiving the encrypted message by the second mobile device;
decrypting the encrypted message by the second mobile device to obtain a decrypted message; and,
performing vocoding functions on the decrypted message by the second mobile device to obtain a decoded message.

15. The method as set forth in claim 14 wherein the initiating comprises manipulating a button on the first mobile device.

16. The method as set forth in claim 14 wherein the initiating comprises manipulating a button on the second mobile device.

17. The method as set forth in claim 14 further comprising:
receiving the encrypted message from the first mobile device to initiate a secure voice communication session;
bypassing selected vocoding functions in the network based on the encrypted message; and,
restoring the selected vocoding functions upon completion of the secure voice communication session.

18. The method as set forth in claim 17 further comprising:
receiving a special message from the second mobile device to initiate a secure voice communication session;
bypassing selected vocoding functions in the network based on the special message; and,
restoring the selected vocoding functions upon completion of the secure voice communication session.

19. A method for providing secure voice communication in a network, the method comprising:
receiving a special request from a mobile device to initiate a secure voice communication session;
bypassing selected vocoding functions in the network based on the special request; and,
restoring the selected vocoding functions upon completion of the secure voice communication session.

20. The method as set forth in claim 19 further comprising:
receiving a second special request from a second mobile device to initiate a secure voice communication session;
bypassing the selected vocoding functions in the network based on the second special request; and,
restoring the selected vocoding functions upon completion of the secure voice communication session.
